(19) United States
(12) Patent Application Publication
(10) Pub. No.: US 2009/0115367 A1
(43) Pub. Date: May 7, 2009

(54) Portable battery DC charger

(76) Inventor: Michael Kidakam, Industry, CA (US)

Correspondence Address: DAVID AND RAYMOND PATENT FIRM, 108 N. YNEZ AVE., SUITE 128, MONTEREY PARK, CA, 91754, US

(21) Appl. No.: 11/982,535

(22) Filed: Nov. 2, 2007

(51) Int. Cl. H02J 7/02; H02J 7/00; H02J 7/32

(52) U.S. Cl. 320/101; 320/103

(57) ABSTRACT

A portable battery DC charger includes a DC power storage having a charging terminal and a discharging terminal, a docking station outfitting the DC power storage to retain the DC power storage at a predetermined orientation, and a utility device integrally provided at the docking station, wherein when the DC power storage is docked at the docking station, the DC power storage is selectively operated to charge the DC power storage at the charging terminal thereof and to discharge the DC power storage at the discharging terminal for charging an internal battery of an electronic device.

### BACKGROUND OF THE PRESENT INVENTION

1. Field of Invention

The present invention relates to a portable charger, and more particularly to a portable battery DC charger which can be recharged though a battery adapter with different recharging configurations to provide a stably electrical charging power to the internal battery of the electronic device.

2. Description of Related Arts

A charger is a device which is adapted for providing electrical energy to a cell or rechargeable battery. With the advance of technology, electronic devices become more and more widely used in modern societies. Since electronic devices such as cellular phones and mp3 players are often used in a portable manner, a rechargeable battery is often used to provide the electrical power to the electronic devices for a pre-determined amount of time. In other words, if the rechargeable battery is not recharged in time, the portable electronic device may not work properly.

Since the quality of the rechargeable batteries varies, some electronic devices have their batteries built-in to protect the electronic devices from being damaged by inferior rechargeable batteries which may provide unstable electrical current to affect the performance of the device, and even shorten the life thereof. Therefore, the built-in battery is designed to prevent the user from randomly replacing it.

However, the design of built-in battery may cause some inconvenience to the user. Since the battery is integrated with the device and the battery is usually recharged through a stationary power outlet, the user may not be able to use the device when the battery is recharged. Also, if the battery is not properly recharged, it may not be able to provide sufficient electrical power to the device lasting for the pre-determined amount of time. In other words, the device may be shut down unexpectedly due to lack of power when the user is using it, and some information or communication would be gone until the battery is recharged. For example, when the user is taking on the cellular phone and the phone is shut down due to lack of power. It may be unlikely for the user to stay besides a power source to wait for battery recharging, and if the recharging takes for a while, the user may not be able to use the phone and deal with something urgent in time.

### SUMMARY OF THE PRESENT INVENTION

A main object of the present invention is to provide a portable battery DC charger for electronic devices, such as cellular phones, MP3 players, or video game players wherein the portable DC power storage is couple with the electronic device to provide electrical power to the electronic device when the internal battery thereof runs out, especially when the user is outside without a stationary power outlet to charge the electronic device.

Another object of the present invention is to provide a portable battery DC charger which can be recharged though a battery adapter with different recharging configurations to provide a stably electrical charging power to the internal battery of the electronic device.

Another object of the present invention is to provide the portable battery DC charger, wherein the DC power storage has a charging terminal and a discharging terminal that the DC power storage is operated to charge at the charging terminal thereof and to discharge at the discharging terminal for charging the internal battery of the electronic device.

Another object of the present invention is to provide the portable battery DC charger which comprises a utility device integrally provided at a docking station, and the portable DC power storage can be charged thereat.

Another object of the present invention is to provide the portable DC power storage which comprises a power indicator indicating a DC power level of the DC power storage.

Accordingly, in order to accomplish the above objects, the present invention provides a portable battery DC charger for an electronic device having an internal battery, comprising:

a DC power storage having a charging terminal and a discharging terminal;

a docking station outfitting the DC power storage to retain the DC power storage at a predetermined orientation; and

a utility device integrally provided at the docking station, wherein when the DC power storage is docked at the docking station, the DC power storage is selectively operated to charge the DC power storage at the charging terminal thereof and to discharge the DC power storage at the discharging terminal for charging the internal battery of the electronic device.

These and other objectives, features, and advantages of the present invention will become apparent from the following detailed description, the accompanying drawings, and the appended claims.

### BRIEF DESCRIPTION OF THE DRAWINGS

FIG. 1 is a portable battery DC charger for an electronic device having an internal battery according to preferred embodiment of the present invention.

FIG. 2 is a front perspective view of the portable battery DC charger according to the preferred embodiment of the present invention, illustrating the utility device integrated with the docking station to form an AC charger.

FIG. 3 is a rear perspective view of the portable battery DC charger according to the preferred embodiment of the present invention, illustrating the utility device integrated with the docking station to form an AC charger.

FIG. 4 illustrates the DC power storage charging the electronic device according to the preferred embodiment of the present invention.

FIG. 5 is a front perspective view of the portable battery DC charger according to the preferred embodiment of the present invention, illustrating the utility device integrated with the docking station to form an automotive charger.

FIGS. 6A and 6B illustrates the utility device integrated with the docking station to form a hand crank charger.

FIG. 7 illustrates the utility device integrated with the docking station to form a solar energy collector.

FIG. 8 illustrates the utility device integrated with the docking station to form a carrying charger for charging the electronic device.

### DETAILED DESCRIPTION OF THE PREFERRED EMBODIMENT

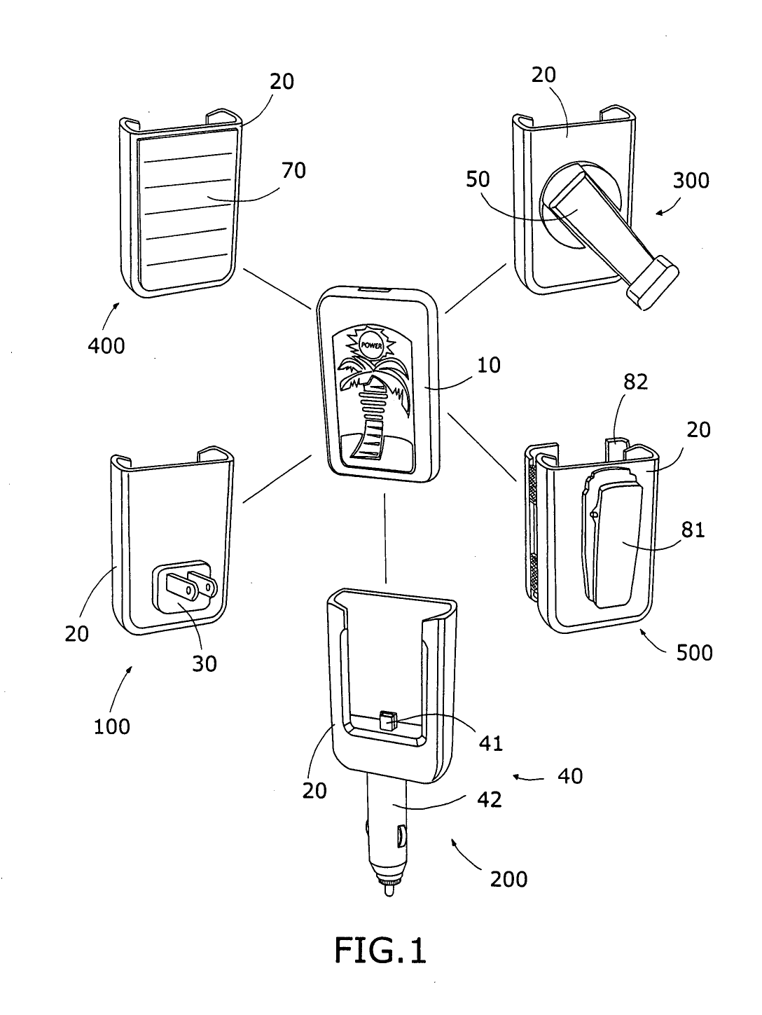

Referring to FIG. 1 of the drawings, a portable battery DC charger for an electronic device having an internal battery according to preferred embodiment of the present invention is illustrated, wherein the portable battery DC charger comprises a DC power storage 10, a docking station 20, and a utility device 30 integrally provided at the docking station 20.

According to the preferred embodiment, the DC power storage 10 has a charging terminal 11 and a discharging terminal 12, wherein the charging terminal 11 is arranged for electrically linking with an external power via the docking station 20 to charge up the DC power storage 10 while the discharging terminal 12 is arranged for coupling with the electronic device via a cable to charge up the internal battery of the electronic device. The DC power storage 10 has a predetermined capacity to store the energy therein.

The docking station 20 is outfitting the DC power storage 10 to retain the DC power storage 10 at a predetermined orientation. Accordingly, the docking station 20 has a top opening 21 and a docking cavity 22 slidably receiving the DC power storage 10 through the top opening 21 so as to retain the DC power storage 10 at an upstanding position.

The utility device 30 is integrally provided at the docking station 20, wherein when the DC power storage 10 is docked at the docking station 20, the DC power storage 10 is selectively operated to charge the DC power storage 10 at the charging terminal 11 thereof and to discharge the DC power storage 10 at the discharging terminal 12 for charging the internal battery of the electronic device. The DC power storage 10 also includes a power indicator 13 indicating a DC power level of the DC power storage 10.

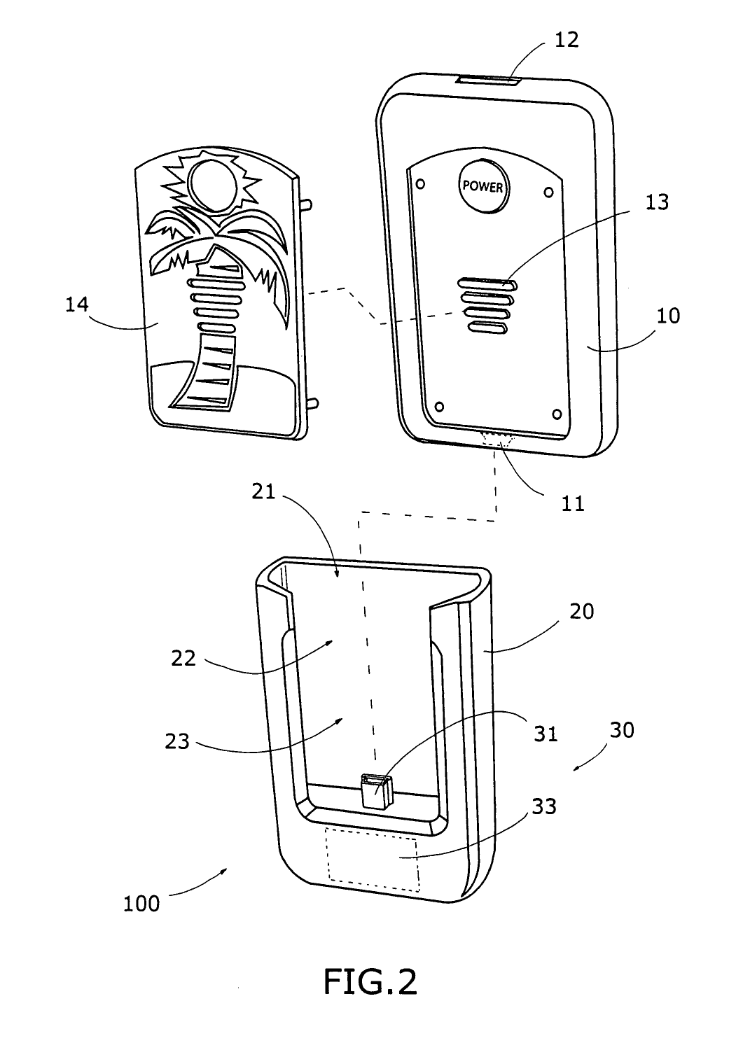

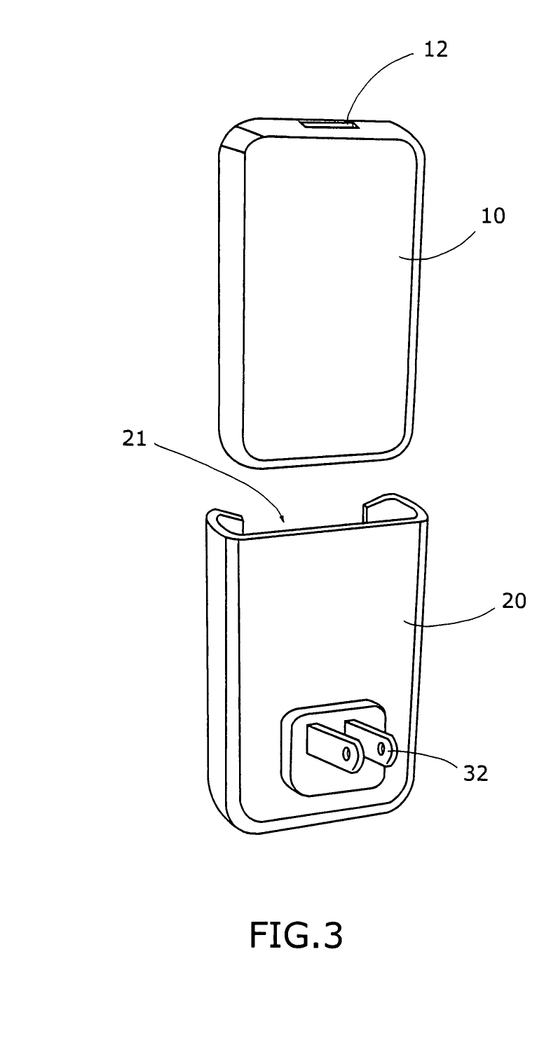

As shown in FIGS. 2 and 3, the utility device 30 is integrated with the docking station 20 to form an AC charger 100. Accordingly, the utility device 30 comprises a power adapter 31 extended within the docking cavity 22 of the docking station 20 to electrically couple with the charging terminal 11 of the DC power storage 10 when the DC power storage 10 is docked in the docking station 20, and an AC adapter 32 outwardly extended from the docking station 20 for electrically connecting an AC external power source so as to charge the DC power storage 10 through the power adapter 31.

Accordingly, the power adapter 31 is upwardly extended from a bottom wall of the docking cavity 22 wherein the AC adapter 32 is rearwardly protruded from a rear wall of the docking station 20. In other words, when the AC adapter 32 is plugged into the wall outlet of the AC external power source, the docking station 20 is supported at the upright position that the top opening 21 of the docking station 20 is facing upward. Therefore, the DC power storage 10 is downwardly slid into the docking cavity 22 through the top opening 21 to align the charging terminal 11 with the power adapter 31.

Moreover, the utility device 30 further comprises an AC-to-DC converting circuit 33 enclosed in the docking station 20 to electrically connect between the power adapter 31 and the AC adapter 32 for converting an AC electrical power to a DC electrical power from the AC external power source to the DC power storage 10. As shown in FIG. 2, the AC-to-DC converting circuit 33 is enclosed in the bottom portion of the docking station 20 below the bottom wall of the docking cavity 22.

It is worth mentioning that the charging terminal 11 and the discharging terminal 12 are provided at top and bottom sides of the DC power storage 10 respectively in such a manner that when the DC power storage 10 is slid into the docking station 20 to electrically couple the charging terminal 11 with the power adapter 31, the discharging terminal 12 of the DC power storage 10 is available for electrically connecting with the electronic device to charge the internal battery thereof.

With speedy progress of telecommunication and semiconductor technology, the electronic devices, such as cellular phones and MP3 players, become smaller and smaller so as to allow users to carry them without any feeling of burden, and nowadays users usually carry and use these electronic devices for a long time each day.

As mentioned above, the quality of the rechargeable batteries varies, some electronic devices have their batteries built-in to protect the electronic devices from being damaged by interior rechargeable batteries which may provide unstable electrical current to affect the performance of the electronic device, and even shorten the life thereof. Users have to be cautious about the power level of their electronic devices to avoid unexpected shut-down of the device due to low power level, which may be annoying especially when the user finds nowhere to recharge his or her device.

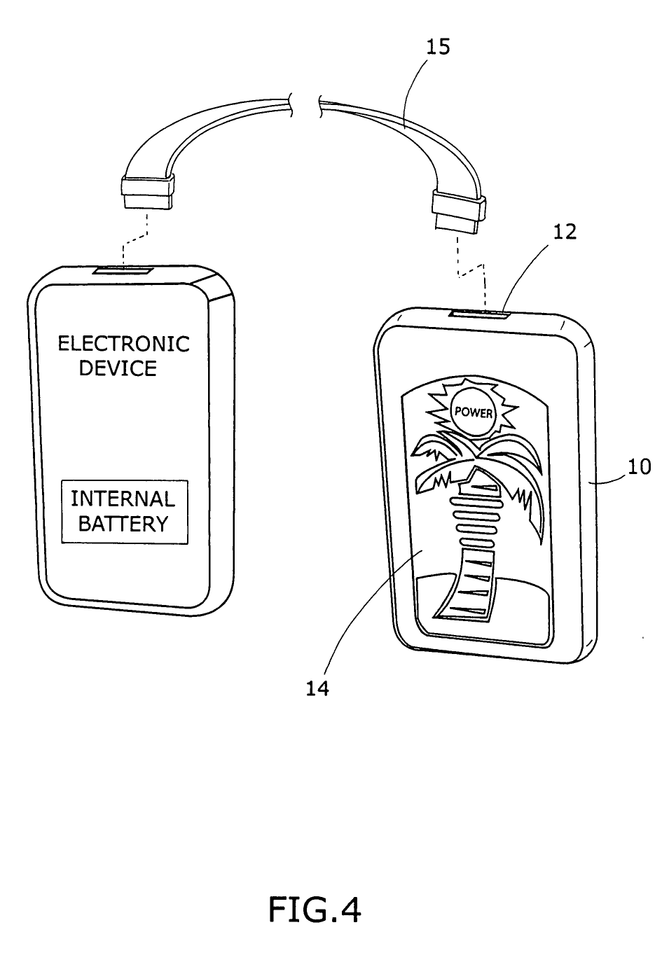

In the present invention, the portable battery DC charger is provided to resolve the problem mentioned above. The DC power storage 10 can be recharged beforehand, wherein the DC power storage 10 is slidably received in the docking cavity 22 of the docking station 20 to electrically couple with the power adapter 31, and the entire docking station 20 (including the power storage 10) is electrically connected to an external AC power source through the AC adapter 32. The power level of the DC power storage 10 is indicated by the power indicator 13. Once the power indicator 13 indicates that the power level of the DC power storage 10 is sufficient to supply electrical energy to the internal battery of the electronic device, the user can remove the DC power storage 10 from the docking station 20 and carry it with him. When the electronic device unexpectedly runs out of battery, a power transfer cable 15 is designed to transfer the electrical energy from the DC power storage 10 to the electronic device, wherein one end of the power transfer cable 15 is connected to the discharging terminal 12 of the DC power storage 10, and the other end of the power transfer cable 15 is connected to the electronic device to transfer the electrical energy, as shown in FIG. 4.

Accordingly, the docking station 20 further has a front window 23 provided at the front side to align with the power indicator 13 when the DC power storage 10 is docked in the docking station 20. It is worth mentioning that when the DC power storage 10 is charged via the docking station 20, the AC charger 100 of the portable battery DC charger of the present invention forms a night light device because the docking station 20 is uprightly supported at the wall.

As shown in FIG. 2, the DC power storage 10 further comprises a decorative cover 14 is detachably mounted at the front side to aligned cover on the power indicator 13. The decorative cover 14, which is made of light transmittable material, can be changed according to the user's desire and the user can also incorporate the power indicator 13 into the decorative cover 14 to increase the entire aesthetic value of the DC power storage 10. For example, as show in FIG. 2, part of the tree on the decorative cover 14 is composed by the power indicator 13, and when DC power storage 10 is being charged, the power indicator is simultaneously moving, which would make the decorative cover 14 more attractive. Therefore, the decorative cover 14 is adapted to enhance the personalization of the DC power storage 10.

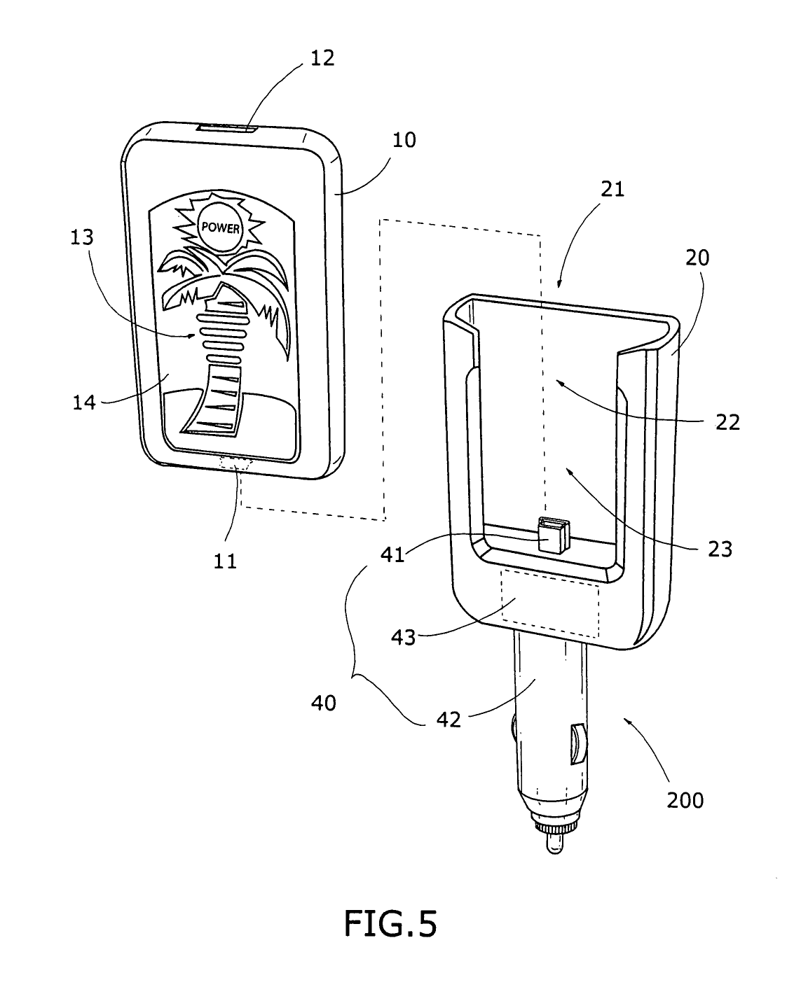

Nowadays, people spend more and more time in driving and most electronic devices provide a DC vehicle adapter for drivers to charge their electronic devices while driving. FIG. 5 illustrates an alternative mode of the utility device 40, wherein the utility device 40 is integrated with the docking station 20 to form a DC vehicle charger 200.

As shown in FIG. 5, the utility device 40 comprises a power adapter 41 extended within the docking cavity 22 of the docking station 20 to electrically couple with the charging terminal 11 of the DC power storage 10 when the DC power storage 10 is docked in the docking station 20, and a DC vehicle power adapter 42 outwardly extended from the docking station 20 for electrically connecting a power outlet of a vehicle so as to charge the DC power storage 10 through the DC vehicle power adapter 42.

Accordingly, the power adapter 41 is upwardly extended from a bottom wall of the docking cavity 22 wherein the DC vehicle power adapter 42 is downwardly protruded from a bottom wall of the docking station 20. When the DC vehicle power adapter 42 is plugged into the power outlet of the vehicle, the docking station 20 is supported at the upright position that the top opening 21 of the docking station 20 is facing upward. Therefore, the DC power storage 10 is downwardly slid into the docking cavity 22 through the top opening 21 to align the charging terminal 11 with the power adapter 41.

The utility device 40 further comprises a DC-to-DC converting circuit 43 enclosed in the docking station 20 to electrically connect between DC vehicle power adapter 42 and the power adapter 41 for converting a vehicle DC power to a DC electrical power from the power outlet of the vehicle to the DC power storage 10. As shown in FIG. 5, the DC-to-DC converting circuit 43 is enclosed in the bottom portion of the docking station 20 below the bottom wall of the docking cavity 22.

Likewise, when the DC power storage 10 is charged through the DC vehicle power adapter 42, the power level of the DC power storage 10 is indicated by the power indicator 13. Once the power indicator 13 indicates that the power level of the DC power storage 10 is sufficient to supply electrical energy to the internal battery of the electronic device, the user can remove the DC power storage 10 from the docking station 20 and carry it with him. Also, the power transfer cable 15 is adapted to transfer electrical energy in the same manner from the DC power storage 10 to electronic devices as mentioned above.

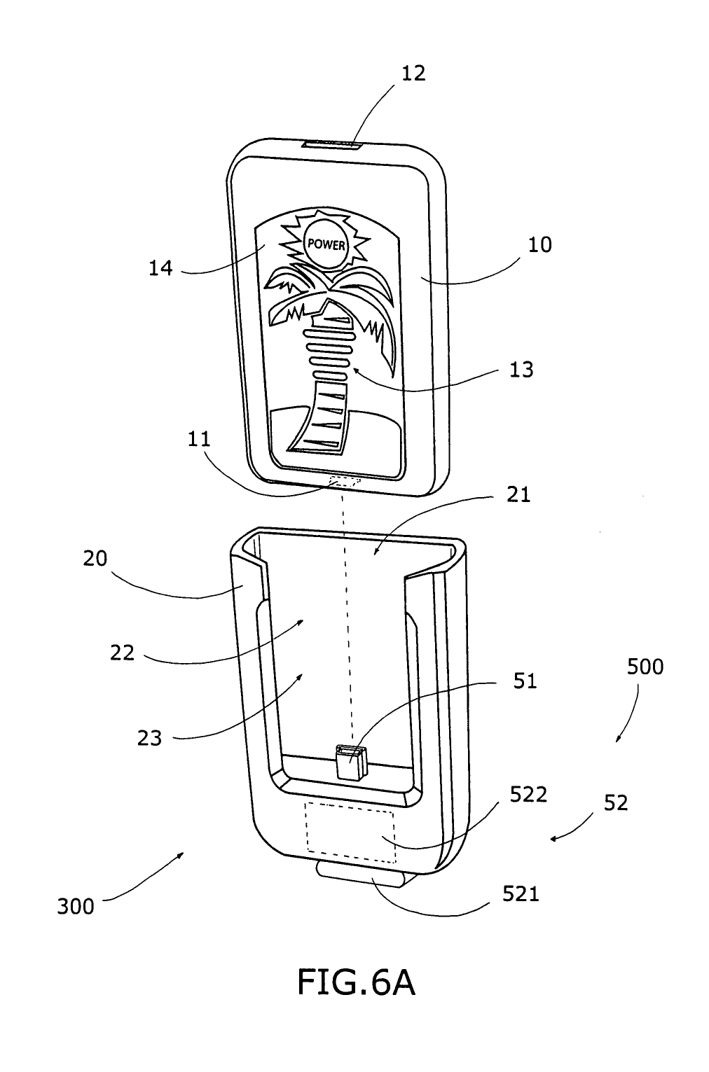

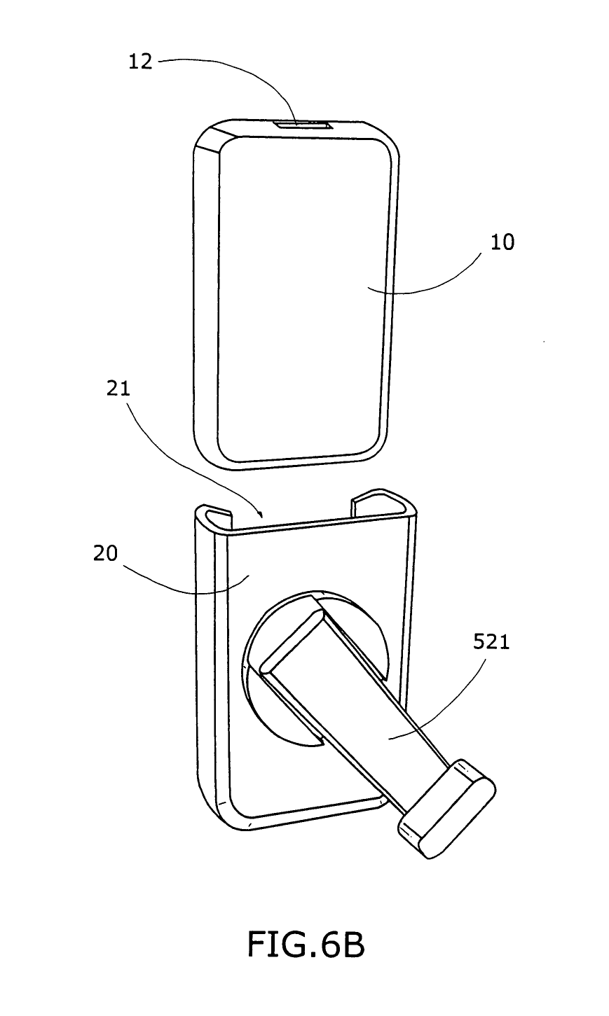

According to Faraday's law of induction, the induced electromotive force in a closed loop equals the negative of the time rate of change of magnetic flux through the loop. Simply speaking, a voltage is produced when moving a conductor (such as a metal wire) through a magnetic field. Another alternative mode of the present invention is based on this physics principle. FIGS. 6A and 6B illustrate an alternative mode of the utility device 50, wherein the utility device 50 is integrated with the docking station 20 to form a hand crank power charger 300.

Referring to FIG. 5, the utility device 50 comprises a power adapter 51 extended within the docking cavity 22 of the docking station 20 to electrically couple with the charging terminal 11 of the DC power storage 10 when the DC power storage 10 is docked in the docking station 20, and a hand crank power generator 52 rotatably coupling with the docking station 20 for manually generating a rotationally mechanical power so as to charge the DC power storage 10 through the power adapter 51. The power adapter 51 is upwardly extended from a bottom wall of the docking cavity 22.

Accordingly, the hand crank power generator 52 comprises a hand crank 521 rotatably mounted at the rear side of the docking station 20, as shown in FIG. 6B, and a power converter 522 enclosed in the docking station 20 to convert the mechanical power to the DC electrical power from the hand crank 521 to the DC power storage 10. As shown in FIG. 6A, the power converter 522 is enclosed in the bottom portion of the docking station 20 below the bottom wall of the docking cavity 22.

Likewise, when the DC power storage 10 is charged through the hand crank power generator 60, the power level of the DC power storage 10 is indicated by the power indicator 13. Also, the power transfer cable 15 is adapted to transfer electrical energy in the same manner from the DC power storage 10 to electronic devices as mentioned above. It is worth mentioning that even though the hand crank power generator 52 generates an unstable electrical power to charge the DC power storage 10, the DC power storage 10 will provide a stable electrical power to charge the internal battery of the electronic device so as to keep the best charging condition of the electronic device.

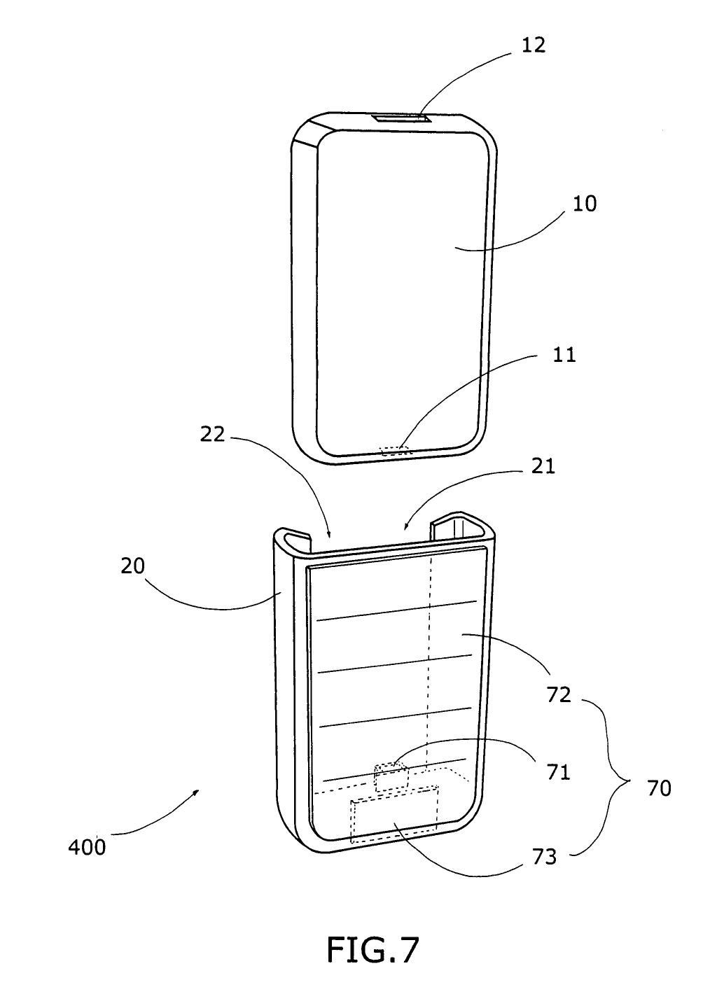

FIG. 7 illustrates an alternative mode of the utility device 70, wherein the utility device 70 is integrated with the docking station 20 to form a solar energy charger 400. As shown in FIG. 7, the utility device 70 comprises a power adapter 71 extended within the docking cavity 22 of the docking station 20 to electrically couple with the charging terminal 11 of the DC power storage 10 when the DC power storage 10 is docked in the docking station 20, and a solar energy collector 72 is integrally provided at a rear side of the docking station 20 for collecting solar energy so as to charge the DC power storage 10 through the power adapter 71. Accordingly, the power adapter 71 is upwardly extended from a bottom wall of the docking cavity 22 wherein the solar energy collector 72 is integrally formed at the rear side of the docking station 20. The utility device 70 further comprises a solar energy converting circuit 73 enclosed in the docking station 20 to convert the solar energy to a DC electrical power from the solar energy collector 72 to the DC power storage 10. As shown in FIG. 7, the solar energy converting circuit 73 is enclosed in the bottom portion of the docking station 20 below the bottom wall of the docking cavity 22.

Likewise, when the DC power storage 10 is charged through the solar energy collector 72, the power level of the DC power storage 10 is indicated by the power indicator 13. Also, the power transfer cable 15 is adapted to transfer electrical energy in the same manner from the DC power storage 10 to electronic devices as mentioned above.

It is worth mentioning that the DC power storage 10 charged with the hand crank power charger 300 or the solar energy charger 400 can be used in emergency situation, such as when a user's cellular phone is unexpectedly shut-off due to low electrical power level of the internal battery, and the user needs to get back to the conversation over the phone immediately, either the hand crank power charger 300 or the solar energy charger 400 can provide immediate electrical power to the electronic device.

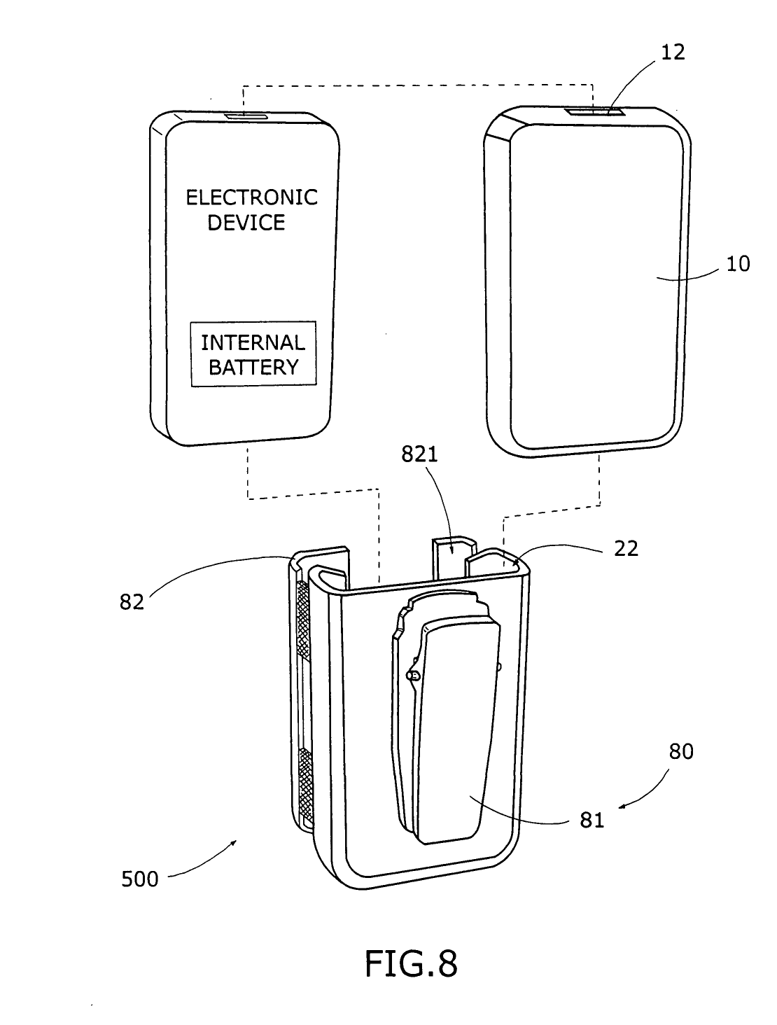

FIG. 8 illustrates an alternative mode of the utility device 80, wherein the utility device 80 is integrated with the docking station 20 to form a carrying charging case 500.

As shown in FIG. 6, the utility device 80 comprises a carrying clip 81 provided at the docking station 20 for being carried at the same time when the DC power storage 10 is discharged for charging the internal battery of the electronic device. Accordingly, the carrying clip 81, which is a belt clip, is provided at the rear side of the docking station 20.

The utility device 80 further comprises a device holder 82 provided at a front side of the docking station 20, wherein the device holder 82 has a size-adjustable holding cavity 821 positioned in front of the docking cavity 22 for holding the electronic device in the holding cavity 821, such that the DC power storage 10 is docked behind the electronic device to charge the internal battery thereof.

As shown in FIG. 1, the DC power storage 10 can be selectively charged by the AC charger 100, the DC vehicle charger 200, the hand crank power charger 300 and the solar energy charger 400. Therefore, the present invention provides a charging kit to safely charge the interior battery of the electronic device. Even though the charging conditions through various chargers (the AC charger 100, the DC vehicle charger 200, the hand crank power charger 300 and the solar energy charger 400) are not perfectly used for directly charging the internal battery of the electronic device, the chargers are used only for charging the DC power storage 10. Therefore, when the DC power storage 10 is charged, the DC power storage 10 will provide the optimum charging condition to stably charge the internal battery of the electronic device so as to protect the internal battery thereof. In addition, the user is able to select different capacities of the DC power storages 10 to be used.

Once the DC power storage 10 is charged by one of the AC charger 100, the DC vehicle charger 200, the hand crank power charger 300 and the solar energy charger 400, the DC power storage 10 is adapted to dock in the carrying charging case 500 and is ready to charge the internal battery of the electronic device. It is worth mentioning that the DC power storage 10 is a universal power storage to fittingly dock in the AC charger 100, the DC vehicle charger 200, the hand crank power charger 300 and the solar energy charger 400 so as to enhance the practice use of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-22. (canceled)

23. A portable battery DC charger for an electronic device having an internal battery, comprising:
a DC power storage having a charging terminal and a discharging terminal;
a docking station outfitting said DC power storage to retain said DC power storage at a predetermined orientation; and
a utility device integrally provided at said docking station, wherein when said DC power storage is docked at said docking station, said DC power storage is selectively operated to charge said DC power storage at said charging terminal thereof and to discharge said DC power storage at said discharging terminal for charging said internal battery of said electronic device, such that when said electronic device runs out of battery, said DC power storage is adapted to provide electricity to said electronic device through a power transfer cable electrically connecting between said discharging terminal of said DC power storage an said electronic device, so that said electronic device is provided with backup power for operation when said internal battery of said electronic device is exhausted.

24. The portable battery DC charger, as recited in claim 23, wherein said charging terminal and said discharging terminal are provided at top and bottom sides of said DC power storage in such a manner that when said DC power storage is slid into said docking station to electrically couple said charging terminal with said power adapter, said discharging terminal of said DC power storage is available for electrically connecting with said electronic device to charge said internal battery thereof.

25. The portable battery DC charger, as recited in claim 24, wherein said utility device comprises a power adapter extended within said docking cavity of said docking station to electrically couple with said charging terminal of said DC power storage when said DC power storage is docked in said docking station, and an AC adapter outwardly extended from said docking station for electrically connecting an AC external power source so as to charge said DC power storage through said power adapter.

26. The portable battery DC charger, as recited in claim 25, wherein said utility device further comprises an AC-to-DC converting circuit enclosed in said docking station to electrically connect between said power adapter and said AC adapter for converting an AC electrical power to a DC electrical power from said AC external power source to said DC power storage.

27. The portable battery DC charger, as recited in claim 25, wherein said docking station has a top opening and a docking cavity slidably receiving said DC power storage through said top opening so as to retain said rechargeable power storage at an upstanding position.

28. The portable battery DC charger, as recited in claim 26, wherein said docking station has a top opening and a docking cavity slidably receiving said DC power storage through said top opening so as to retain said rechargeable power storage at an upstanding position.

29. The portable battery DC charger, as recited in claim 27, wherein said DC power storage comprises a power indicator indicating a DC power level of said DC power storage.

30. The portable battery DC charger, as recited in claim 28, wherein said DC power storage comprises a power indicator indicating a DC power level of said DC power storage.

31. The portable battery DC charger, as recited in claim 23, wherein said utility device comprises a power adapter extended within said docking cavity of said docking station to electrically couple with said charging terminal of said DC power storage when said DC power storage is docked in said docking station, and a DC vehicle adapter outwardly extended from said docking station for electrically connecting a power outlet of a vehicle so as to charge said DC power storage through said power adapter.

32. The portable battery DC charger, as recited in claim 31, wherein said utility device further comprises a DC-to-DC converting circuit enclosed in said docking station to electrically connect between said power adapter and said DC adapter for converting a vehicle DC power to a DC electrical power from said power outlet of a vehicle to said DC power storage.

33. The portable battery DC charger, as recited in claim 32, wherein said DC power storage comprises a power indicator indicating a DC power level of said DC power storage.

34. The portable battery DC charger, as recited in claim 23, wherein said utility device comprises a power adapter extended within said docking cavity of said docking station to electrically couple with said charging terminal of said DC power storage when said DC power storage is docked in said docking station, and a hand crank power generator rotatably coupling with said docking station for manually generating a rotationally mechanical power so as to charge said DC power storage through said power adapter.

35. The portable battery DC charger, as recited in claim 34, wherein said utility device further comprises a power converter enclosed in said docking station to electrically connect between said power adapter and said DC adapter for converting mechanical power to a DC electrical power from said hand crank power generator to said DC power storage.

36. The portable battery DC charger, as recited in claim 35, wherein said DC power storage comprises a power indicator indicating a DC power level of said DC power storage.

37. The portable battery DC charger, as recited in claim 23, wherein said utility device comprises a carrying clip provided at said docking station for being carried at the same time when said DC power storage is discharged for charging said internal battery of said electronic device.

38. The portable battery DC charger, as recited in claim 37, wherein said utility device further comprises a device holder having a size-adjustable holding cavity positioned in front of said docking cavity for holding said electronic device in said holding cavity, such that said DC power storage is docked behind said electronic device to charge said internal battery thereof.

39. The portable battery DC charger, as recited in claim 38, wherein said DC power storage comprises a power indicator indicating a DC power level of said DC power storage.

40. The portable battery DC charger, as recited in claim 23, wherein said utility device comprises a power adapter extended within said docking cavity of said docking station to electrically couple with said charging terminal of said DC power storage when said DC power storage is docked in said docking station, and a solar energy collector integrally provided at a rear side of said docking station for collecting solar energy so as to charge said DC power storage through said power adapter.

41. The portable battery DC charger, as recited in claim 40, wherein said utility device further comprises a solar energy converting circuit enclosed in said docking station to electrically connect between said power adapter and said DC adapter for converting said solar energy to a DC electrical power from said solar energy collector to said DC power storage.

42. The portable battery DC charger, as recited in claim 41, wherein said DC power storage comprises a power indicator indicating a DC power level of said DC power storage.
